(19) United States
(12) Patent Application Publication
(10) Pub. No.: US 2008/0073370 A1
(43) Pub. Date: Mar. 27, 2008

(54) APPARATUS AND METHODS FOR PORTIONING AND DISPENSING A FROZEN PRODUCT

(76) Inventor: David B. Anderson, St. George, UT (US)

Correspondence Address: STOEL RIVES LLP - SLC, 201 SOUTH MAIN STREET, ONE UTAH CENTER, SALT LAKE CITY, UT, 84111, US

(21) Appl. No.: 11/858,676

(22) Filed: Sep. 20, 2007

Related U.S. Application Data
(60) Provisional application No. 60/846,775, filed on Sep. 22, 2006.

(51) Int. Cl. B65G 47/14; G07F 11/00

(52) U.S. Cl. 221/1; 221/12

(57) ABSTRACT

Apparatus and methods for portioning and dispensing a frozen product, another viscous fluid, or the like, are disclosed. In one embodiment, a frozen food product is pressed between a first and second surface as the first and second surfaces are approximated in a portioning container, to thereby form a dispensable portion. The second surface may separate to allow the formed frozen product to be dispensed from the apparatus. In one embodiment, the apparatus may further comprise a storage container for the frozen product, wherein a portion of the frozen product in the storage container is transferred to the portioning container as the frozen product in the storage container is rotated and advanced against a cutting blade.

### RELATED APPLICATIONS

This application claims the benefit under 35 U.S.C. § 119(e) of U.S. Provisional Patent Application No. 60/846,775, filed Sep. 22, 2006, and titled “APPARATUS AND METHODS FOR PORTIONING AND DISPENSING A FROZEN PRODUCT,” which is incorporated herein by specific reference.

### BRIEF DESCRIPTION OF THE DRAWINGS

Understanding that the drawings depict only typical embodiments of the invention and are not therefore to be considered to be limiting of its scope, the invention will be described and explained through the use of the accompanying drawings in which:

FIG. 1 is a perspective view of an embodiment of the invention.

FIG. 2 is a cross sectional view an embodiment of the invention.

FIG. 3 is a perspective view of an embodiment of a push mechanism.

FIG. 4 is a transparency view of an embodiment of a portioning container and related structures.

FIG. 5 is an overhead perspective view of another embodiment of the invention.

FIG. 6A is a detailed view of an embodiment of a lower surface assembly as used in various embodiments of the invention, shown in a closed configuration.

FIG. 6B is a detailed view of the embodiment of a lower surface assembly shown in FIG. 6A, shown in an open configuration.

FIG. 7 is a detailed view of an alternative embodiment of a lower surface assembly.

FIG. 8 is a perspective view of one embodiment of a wiper drive assembly and lower surface actuation assembly.

FIG. 9 is a cross-sectional view of the wiper drive and lower surface actuation assemblies of FIG. 8.

FIG. 10 is a flow diagram of a sequence of operations in one implementation of a method for portioning and dispensing a frozen product.

### DETAILED DESCRIPTION OF PREFERRED EMBODIMENTS

In the following description, numerous specific details are provided for a thorough understanding of the various embodiments of the invention. However, those skilled in the art will recognize that the invention can be practiced without one or more of the specific details, or with other methods, components, materials, etc. In addition, in some cases, well-known structures, materials, or operations are not shown or described in detail in order to avoid obscuring aspects of the invention. Furthermore, the described features, structures, or characteristics may be combined in any suitable manner in one or more embodiments.

Disclosed herein are apparatus and methods for portioning and dispensing a frozen product, such as a frozen food product, or another viscous fluid or other similar substance. In some embodiments, the frozen product is stored within a storage container that may be configured to be rotated and advanced towards a portioning container. A cutting blade may be positioned to facilitate transferal of a portion of the frozen product from the storage container to the portioning container. The portioning container may include two surfaces, which may be used to press the frozen product therebetween to form a dispensable portion.

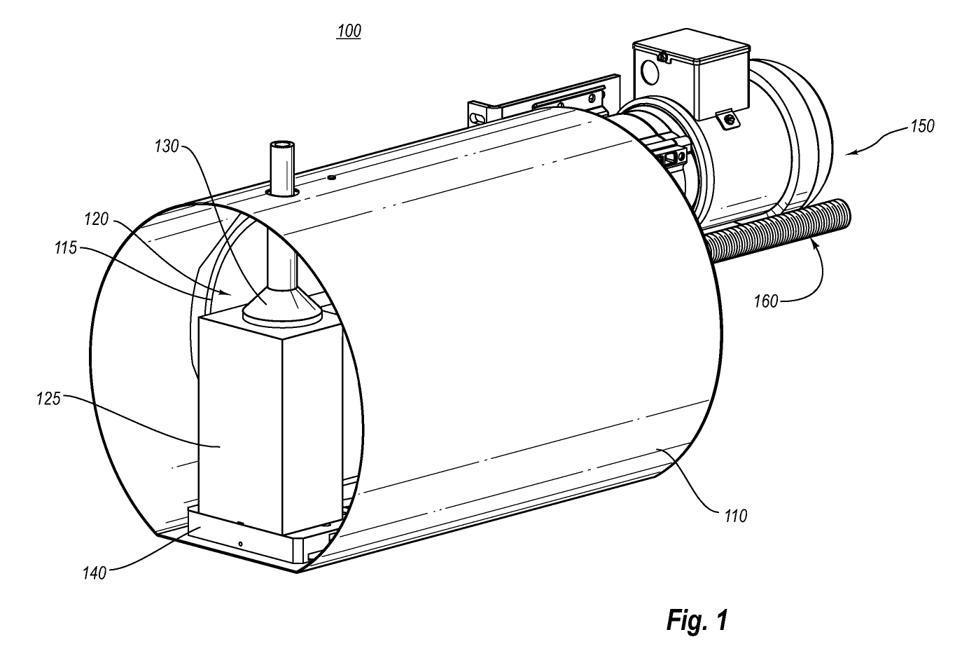

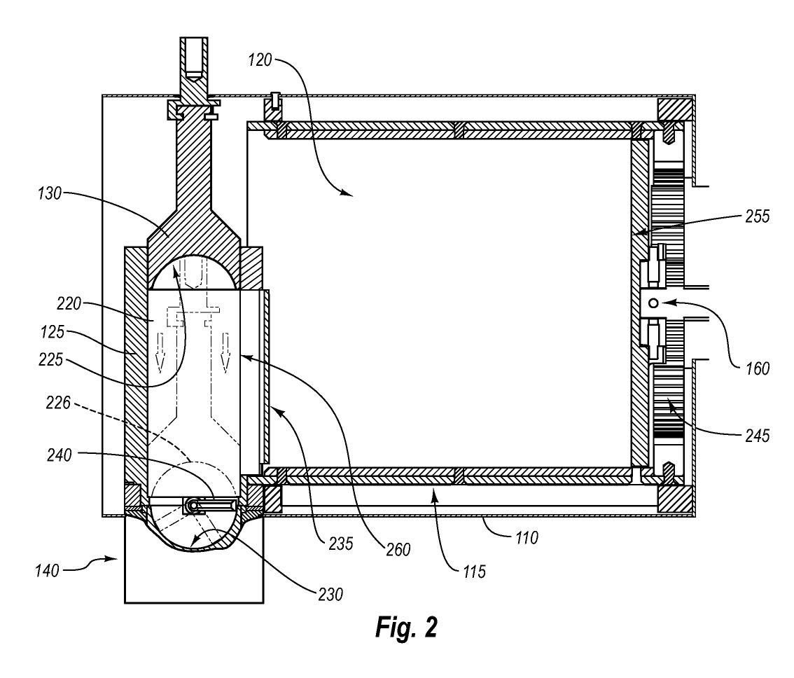

FIGS. 1-2 show an embodiment of an apparatus 100 for automatically portioning and dispensing a frozen product. As shown in these figures, the apparatus 100 includes a housing 110, a storage container 115, and a portioning container 125. Portioning container 125 defines interior 220 and storage container 115 defines interior 120.

The interior 120 of storage container 115 is preferably adapted to receive a frozen product to be portioned and dispensed by the apparatus. For example, the embodiment depicted in FIG. 1 has been adapted to receive a frozen product that is generally cylindrical in shape within interior 120. Various other shapes of storage containers may be used as may be dictated by the shape of the frozen product to be portioned and dispensed by apparatus 100. Apparatus 100 may further be configured with one or more adapters to allow storage container 115 to receive various frozen products stored in containers having a variety of different shapes (i.e., square ice-cream containers and the like).

In the embodiment of FIG. 1, storage container 115 is configured to rotate within housing 110. The rotational movement of storage container 115 may be generated by an electrical motor system 150. In some embodiments, a spur gear may be provided that meshes with a ring gear attached to storage container 115 to provide for rotation of storage container 115. Of course, any of a number of other mechanisms may alternatively be used, such as a pneumatic actuator, a hydraulic mechanism, or the like. Any of the foregoing may be considered examples of means for rotating a frozen product or other such substance.

Portioning container 125 is adapted to receive a portion of the frozen product from storage container 115. The interior portion of portioning container 125 may be cylindrical in shape, as shown in FIG. 2. The portioning container 125 may include a first surface assembly 130 and second surface assembly 140. As described below, the frozen product in portioning container 125 may be formed into a dispensable portion by pressing the frozen product in portioning container 125 between a surface 225 on first surface assembly 130 and an opposite surface 230 on second surface assembly 140.

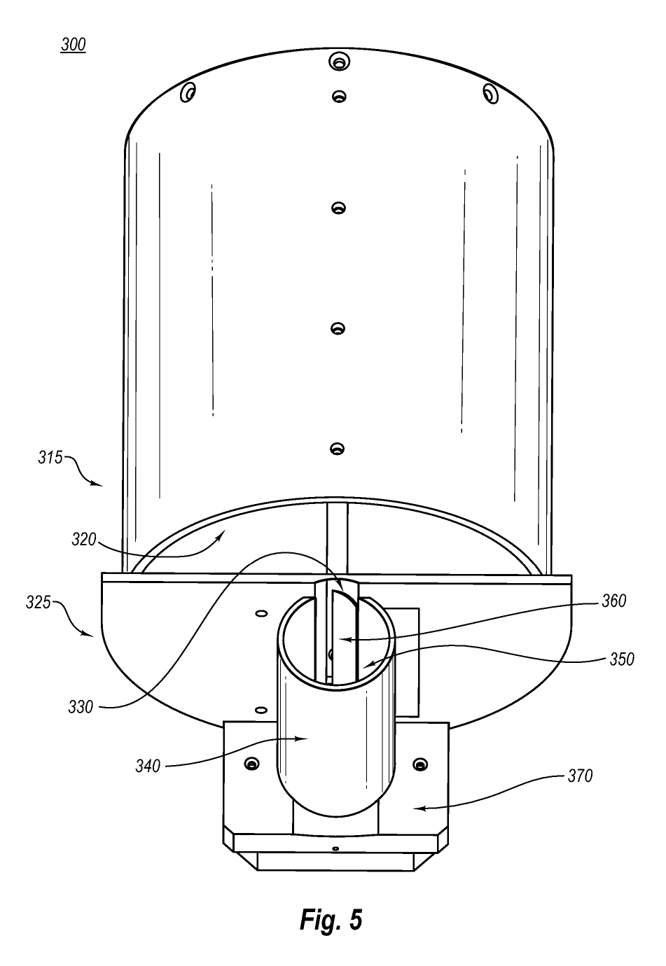

A portion of the frozen product in storage container 115 may be transferred to portioning container 125 via an opening slit 260 in portioning container 125. An opening slit of another embodiment of the invention is shown in FIG. 5 at 360. The opening slit 260 of portioning container 125 may be oriented towards the interior 120 of storage container 115 so that a portion of the frozen product in the interior 120 of storage container 115 may be transferred to the portioning container 125 as the frozen product in storage container 115 is rotated and advanced towards portioning container 125.

In the embodiment of FIG. 1, first surface assembly 130 is movably mounted within portioning container 125. This allows first surface 225 to move from an upper portion of portioning container 125 to a lower portion of portioning container 125, as shown in phantom in FIG. 2. Second surface assembly 140 is fixedly mounted to housing 110 so as to define a lower portion of portioning container 125. As the first surface assembly 130 moves from the upper portion of portioning container 125 to a lower portion of portioning container 125, the frozen product in portioning container 125 is pressed between first surface 225 and second surface 230.

In apparatus 100, first surface assembly 130, portioning container 125, and second surface assembly 140 may be detached from housing 110. When these components are removed, the interior of storage container 115 may be accessed, thereby allowing storage container 115 to be cleaned, frozen product to be loaded into storage container 115, and the like.

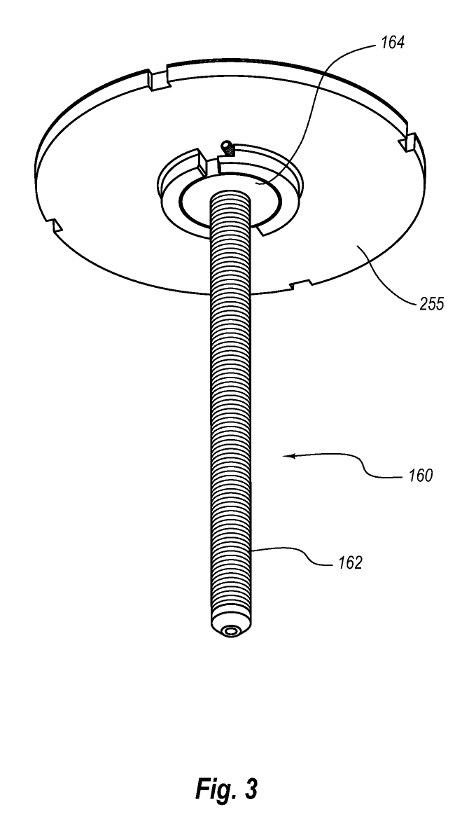

Apparatus 100 may further comprise a push-plate 255 (shown in FIGS. 2 and 3) to advance the frozen product in storage container 115 in the direction of portioning container 125. The push-plate 255 may be advanced via a push mechanism 160, which may comprise a pneumatic piston, screw-drive, or the like. Push mechanism 160 may be powered by electric motor 150, a pneumatic source, or any other available power source.

FIG. 2 provides a cross-sectional view of apparatus 100. In this view, it can be seen that storage container 115 further comprises geared section 245. Geared section 245 may be used in connection with electric motor system 150, or another power source, to cause storage container 115 to rotate within housing 110. As the storage container 115 rotates, push-plate 255 may be advanced towards portioning container 125. When storage container 115 contains a frozen product, the movement of push-plate 255 may accordingly cause the frozen product to be pushed towards portioning container 125. In some embodiments, the push plate may be advanced simultaneously with the rotation of the portioning container 125. In the embodiment depicted in FIG. 2, this is accomplished by providing a threaded shaft 162, which may be connected with push plate 255, as best seen in FIG. 3, and threaded through an opening in a fixed portion of the device. By providing such an arrangement, rotation of push plate 255 results in automatic, simultaneous advancement of push plate 255. As discussed above, push-plate 255 may be moved via a pneumatic piston, screw-drive, or any other available structure or method.

FIG. 3 depicts a close-up view of push mechanism 160. Push mechanism 160 includes a threaded shaft 162, which is connected with pusher plate 255 via coupler attachment 164. Threaded shaft 162 may be threaded into a corresponding threaded opening (not shown) in the housing of the machine. As storage container 115 is rotated, threaded shaft 162 therefore advances pusher plate 255 and moves the frozen food product or other substance towards the portioning container 125. Push mechanism 160, or another mechanism on the device, may include one or more sensors to determine the position of the pusher plate on the threaded shaft 162. For example, a first sensor may indicate when the pusher plate has fully dispensed the frozen product. Upon detecting that the frozen product has been fully dispensed, the device may be configured to automatically retract the pusher plate to allow for loading of the machine with another container of product. A second sensor may also be provided in some embodiments to allow the pusher plate to stop retracting at an appropriate position. Push mechanism 160 is one example of a means for advancing a frozen product or other such substance.

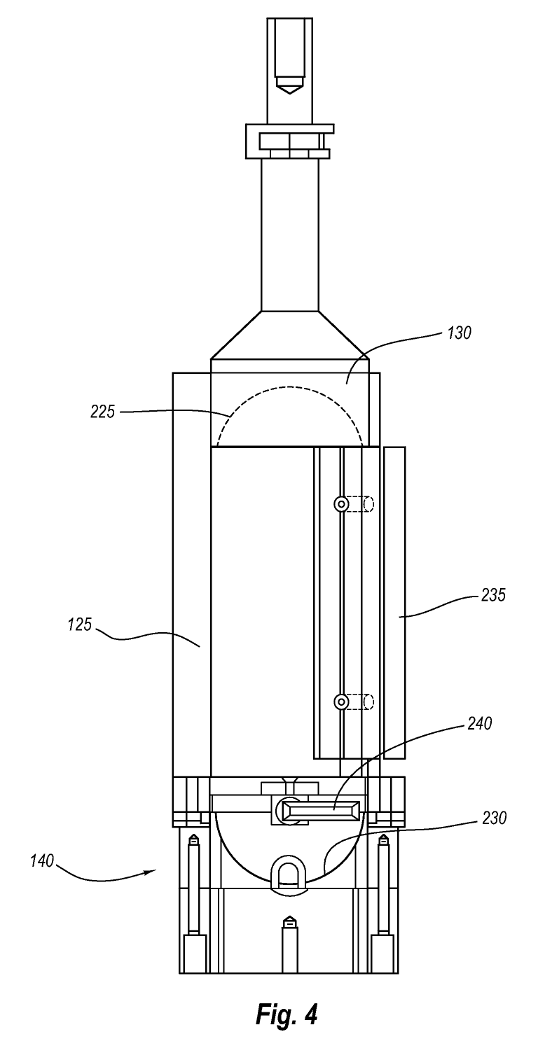

Apparatus 100 also includes a cutting blade 235, as shown in FIGS. 2 and 4. Cutting blade 235 may be disposed between portioning container 125 and storage container 115. In some embodiments, cutting blade 235 is disposed at least partially within opening slit 260 and may also be angled towards the interior 120 of storage container 115. In some embodiments, cutting blade 235 is angled such that a portion of frozen product is sliced by cutting blade 235 and transferred from storage container 115 to portioning container 125 through opening slit 260 as the frozen product is rotated and advanced against cutting blade 235. In some embodiments, cutting blade 235 is formed from an extruded portion of portioning container 125. This extruded portion may also coincide with a portion of opening slit 260. In other embodiments, cutting blade 235 may be formed from steel or another hard metallic material. In these embodiments, cutting blade 235 may be attached to portioning container 125 at opening slit 260 via welding, bolting, screwing, or the like. Cutting blade 235 is one example of a means for slicing a portion of a frozen product or other such substance.

As mentioned above, the frozen product in the interior 120 of storage container 115 may be rotated and pressed towards cutting blade 235 by push-plate 255. The rotational movement and pressure from push-plate 255 may be used to cause cutting blade 235 to slice the frozen product. The angle of cutting blade 235 may be configured to transfer the sliced portion of frozen product into the interior 220 of portioning container 125 as the frozen product is rotated and advanced against the cutting blade 235.

The amount of frozen product transferred from the interior 120 of storage container 115 to the interior 220 of portioning container 125 may be dictated by the rotation rate of the storage container 115 and/or the rate of advancement towards the cutting blade 235 of push mechanism 160. Therefore, in some embodiments, one or both of these movements may be varied as desired by an operator to thereby vary the amount of frozen product dispensed by the machine.

As previously described, first surface assembly 130, which defines first surface 225, is movably connected to portioning container 125. First surface assembly 130 may be moved from an upper portion of portioning container 125 to a lower position 225 of portioning container 125. As the first surface assembly 130 moves towards the second surface assembly 140, the frozen product in the interior 220 of portioning container 125 is pressed between surface 225 and stationary surface 230 and formed into a dispensable portion. Of course, other embodiments are contemplated in which the bottom surface is moved towards a stationary top surface, or wherein both surfaces are simultaneously moved towards one another.

In some embodiments, first surface 225 and second surface 230 are both generally hemispherically shaped, such that, as first surface 225 is moved to position 226 (FIG. 2), the frozen product in the interior 220 of portioning container 125 is formed into a generally spherical portion. In FIG. 2, first surface 225 and second surface 230 are shown as forming a generally spherical shape when first surface 225 is in position 226, wherein the first hemisphere of the sphere is formed by first surface 225 in position 226 and the second hemisphere of the sphere is formed by second surface 230. Surfaces 225 and 230 are examples of means for forming a sliced frozen product or other such substance into a dispensable portion.

Apparatus 100 may also include a wiper blade 240, which may be rotatably positioned within container 125 adjacent to second surface 230. Wiper blade 240 may be configured to rotate in a pattern comprising a 360-degree rotation. In this pattern, wiper blade 240 wipes first surface 225 and second surface 230. Wiper blade 240 may also, or alternatively, be configured to rotate in a second pattern. In the second pattern, wiper blade 240 may rotate approximately in a single hemisphere of 180 degrees. During the second rotation pattern, wiper blade 240 may only rotate in the hemisphere defined by first surface 225 when first surface 225 is in position 226. In the second rotation pattern, wiper blade 240 may not rotate in the hemisphere defined by lower surface 230. Wiper blade 240 may be used, for example, to help prevent the formed frozen product in portioning container 125 from sticking to first surface 225 or second surface 230.

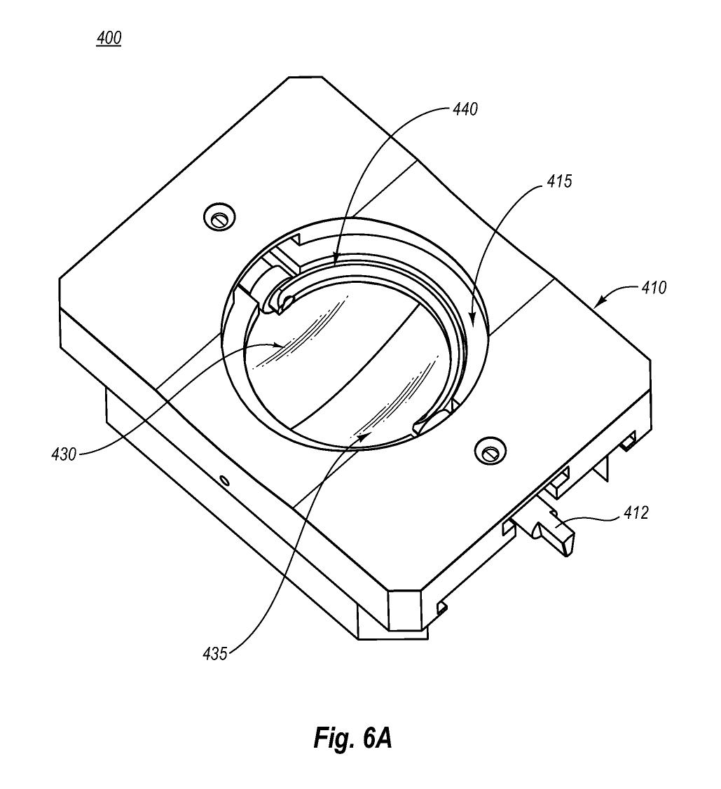

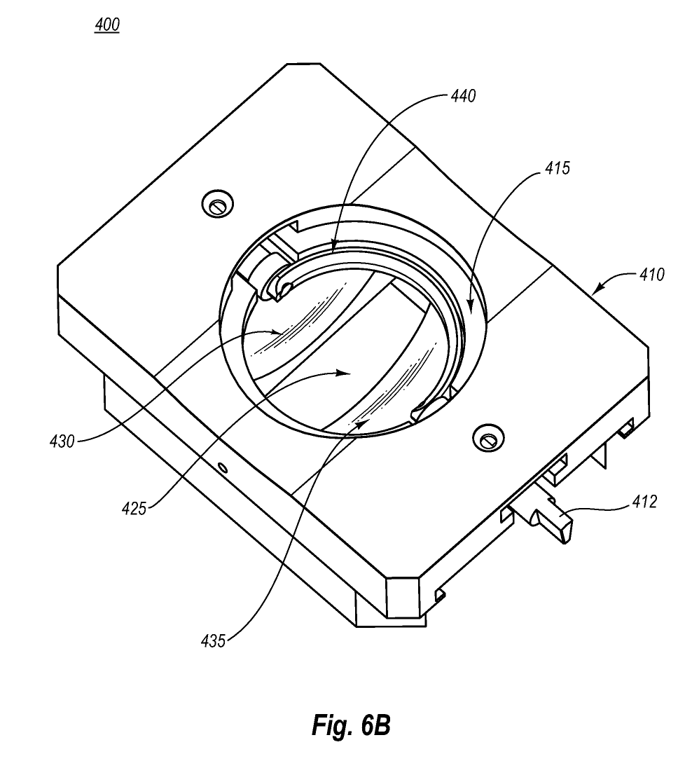

In some embodiments, second surface 230 of second surface assembly 140 is separable so as to form an opening in container 125. In such embodiments, after first surface 225 is approximated to second surface 230, at position 226, second surface 230 may separate to allow the formed frozen product in portioning container 125 to be dispensed from the apparatus. In embodiments employing both of the aforementioned wiper patterns, the first pattern may be deployed prior to formation of the opening in container 125 and the second pattern deployed after the formation of the opening. This may be desirable for some implementations because rotation of wiper blade 240 in the hemisphere defined by lower surface 230 could interfere with the formed frozen product's exit from the apparatus and further could present a possible safety hazard. The separation of second surface 140 is discussed in more detail below in conjunction with FIGS. 6A and 6B.

In some embodiments, the storage container 115 may be refrigerated to keep the frozen product cold between periods of use during which frozen product is dispensed. The refrigeration unit (not shown) may be configured to maintain the temperature of the interior portion 120 of storage container 115 at an appropriate temperature to maintain frozen product in a desired frozen state. For instance, if the apparatus were to be used to portion and dispense hard ice-cream, the refrigeration unit may maintain interior portion 120 of storage container 115 at between about minus four degrees and about two degrees Fahrenheit and, if the apparatus were to be used to portion and dispense sorbet, the refrigeration unit may maintain interior portion 120 of storage container 115 at between about minus six degrees and about two degrees Fahrenheit. In one embodiment, the refrigeration unit further comprises a control system that allows a user to adjust the temperature of storage container 115 to the user's preference.

In some embodiments, one or more of portioning container 125, cutting blade 235, first surface assembly 130, and second surface assembly 140 may be detached from housing 110. When these components are removed, the interior of the device may be accessed for cleaning, loading of frozen product, etc.

FIG. 5 is an upper perspective view of another embodiment of an automatic frozen product portioning and dispensing apparatus 300. The embodiment of FIG. 5 includes portioning container 340 and storage container 315. These containers may be disposed within a housing, as with apparatus 100, but the housing is not shown in FIG. 5 so as to further clarify the internal workings of one embodiment of the invention. Storage container 315 may be configured to rotate within the housing, similar to storage container 115 of apparatus 100.

The embodiment of FIG. 5 may also include a push-plate (not shown), such as the push-plate 255 shown in FIGS. 2 and 3. As the storage container 315 rotates, the push plate may be used to advance the frozen product in storage container 315 towards cutting blade 330.

In the embodiment of FIG. 5, a plate 325 is also provided, which may cover a substantial portion of the opening of storage container 315. Plate 325 may also have an opening 360 to allow the frozen product sliced by cutting blade 330 to be transferred from storage container 315 to portioning container 340. In this configuration, plate 325 may help keep the frozen product within storage container 315 and thereby prevent spilling.

Apparatus 300 may further include a first surface assembly (not shown) and second surface assembly 370. The first surface assembly may be configured to slide within the interior 350 of portioning container 340. As with apparatus 100, the frozen product in the interior 350 of portioning container 340 may be formed into a dispensable portion as a surface associated with the first surface assembly (not shown) is approximated with a surface associated with the second surface assembly 370.

In some embodiments, plate 325, storage container 340, cutting blade 330, and second surface assembly 370 may be removed from storage container 315. When these components are removed, the interior portion 320 of storage container 315 may be easily accessed to allow frozen product to be loaded into storage container 315, for cleaning, and the like. Storage container 315 may further comprise an adapter to allow the apparatus to be used in connection with frozen products of various sizes and shapes.

FIGS. 6A and 6B provide a detailed view of a second surface assembly 400 as may be provided for use in various embodiments of the invention. Second surface assembly 400 may include a body 410. Body 410 may be adapted for connection with a portioning container, as shown in FIGS. 1 and 2. Body 410 may be further adapted to allow for selective attachment and removal from housing 110.

Second surface assembly 400 may include a hemispherically shaped surface for forming the formed product into a dispensable portion, as shown in FIG. 6A. In the embodiment of FIGS. 6A and 6B, the recessed surface is comprised of two separable surfaces, 430 and 435. When joined, separable surfaces 430 and 435 create a surface that is generally hemispherical in shape. FIG. 6A depicts the surface with separable surfaces 430 and 435 joined to form a hemispherical shape. FIG. 6B depicts second surface assembly 400 after separable surfaces 430 and 435 have been separated. As shown in FIG. 6B, the separation of separable surfaces 430 and 435 creates opening 425. In some embodiments, a formed portion of frozen product may be dispensed from the apparatus through opening 425.

The body 410 of second surface assembly 400 may further include recessed portion 415. Recessed portion 415 may be configured to connect with a first surface assembly, such as first surface assembly 130 shown in FIGS. 1, 2, and 4. In some embodiments, the first surface (formed by the combination of separable surfaces 430 and 435 in the embodiment of FIGS. 4A and 4B) is hemispherically shaped. Thus, when the first surface assembly is approximated with the second surface assembly 400, the first surface assembly may fit into and mate with recessed area 415. As shown in FIG. 2, the resulting combination may create a generally spherical area between the first and second surfaces when the two surfaces are approximated. Thus, any frozen product pressed between the first surface and second surface may be formed into a generally spherical shape.

In some embodiments, second surface assembly 400 further includes a wiper blade 440. Wiper blade 440 may be disposed adjacent separable surfaces 430 and 435, and may be configured to rotate within one or more rotation patterns. As described above, wiper blade 440 may be configured to rotate in a first rotational pattern of 360 degrees. The first rotational pattern of wiper blade 440 may wipe the separable surfaces 430 and 435 when separable surfaces 430 and 435 are joined to form a spherical shape. In some embodiments, the first rotational pattern of wiper blade 440 also wipes the first or upper surface after the first surface has been approximated to the second surface. The first rotational pattern may perform multiple rotations if desired.

In some embodiments, wiper blade 440 may be configured to rotate in a second rotational pattern when separable surfaces 430 and 435 are apart so as to form opening 425. As described above, the second rotational pattern may rotate wiper blade 440 approximately 180 degrees. The second rotational pattern may confine the rotation of wiper blade 440 to substantially the upper hemisphere of the sphere, as rotation in the lower hemisphere could prevent formed frozen product from exiting the apparatus via opening 425. Further, rotation in the lower hemisphere while the surfaces 430, 435 are separated could pose a safety risk because the wiper blade could come into contact with fingers or other body parts entering the apparatus through opening 425. The second rotation pattern of wiper blade 440 may be used to assist the exit of the formed frozen product from the apparatus by preventing the formed frozen product from sticking to the first (upper) surface. Wiper blade 440 and separable surfaces 430 and 435 are examples of means for dispensing a formed portion of a frozen product or other such substance.

FIGS. 6A and 6B also depict an actuation member 412, which may be connected with a hydraulic, electric, or other power source to provide the force used to rotate wiper blade 440. Actuation member 412 is configured such that rotation of actuation member results in a corresponding rotation of wiper blade 440.

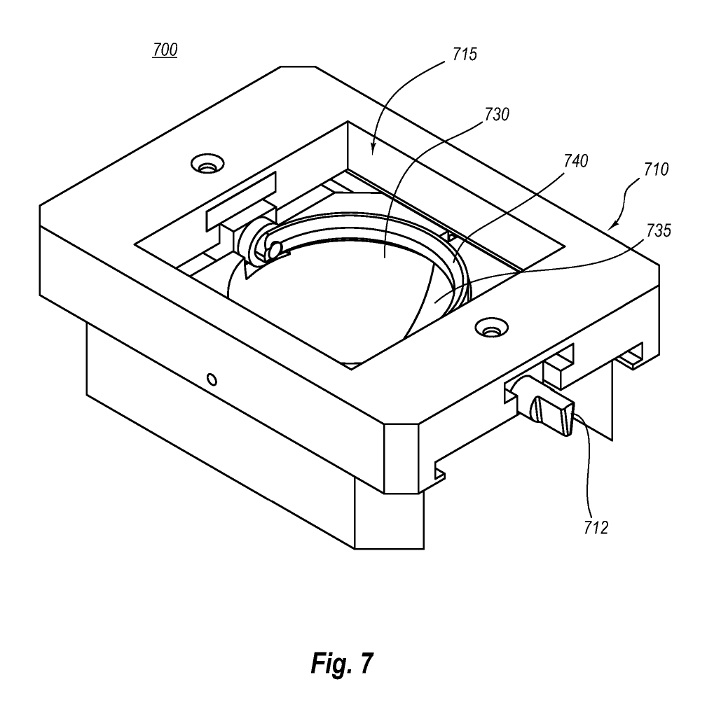

FIG. 7 depicts an alternative second surface assembly 700 that may be used in other embodiments of the invention. Unlike second surface assembly 400 of FIGS. 6A and 6B, second surface assembly 700 has a recessed portion 715 that has a rectangular cross-section. Second surface assembly 400 is otherwise similar to second surface assembly 400 of FIGS. 6A and 6B, and includes a wiper blade 740, along with an actuation member 712 configured to, upon rotation, result in the rotation of wiper blade 740.

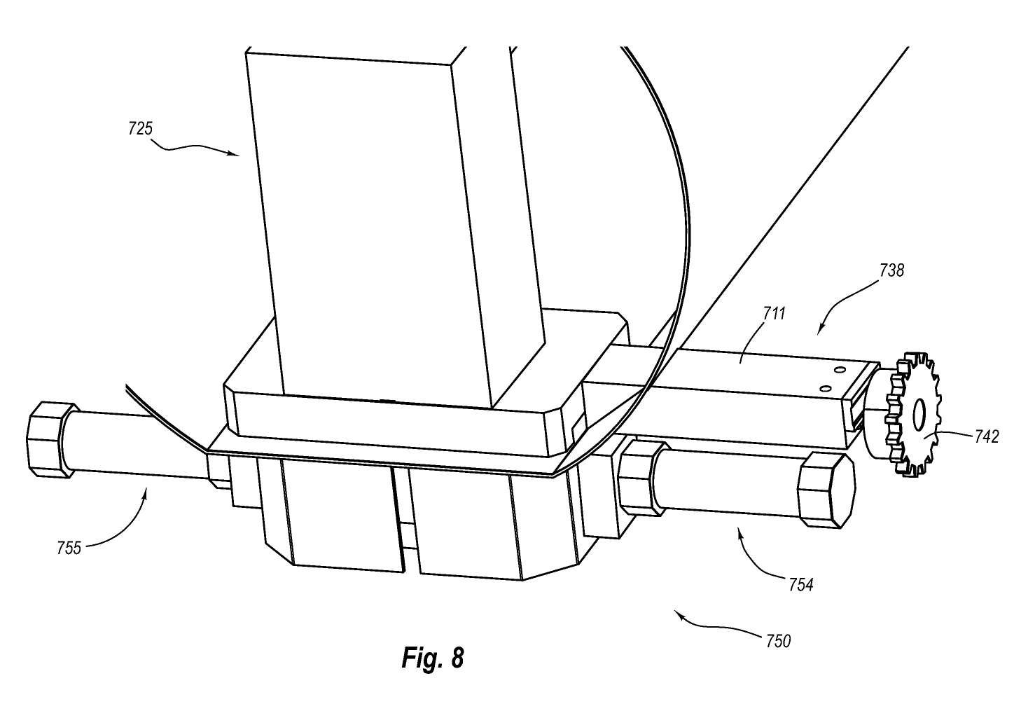

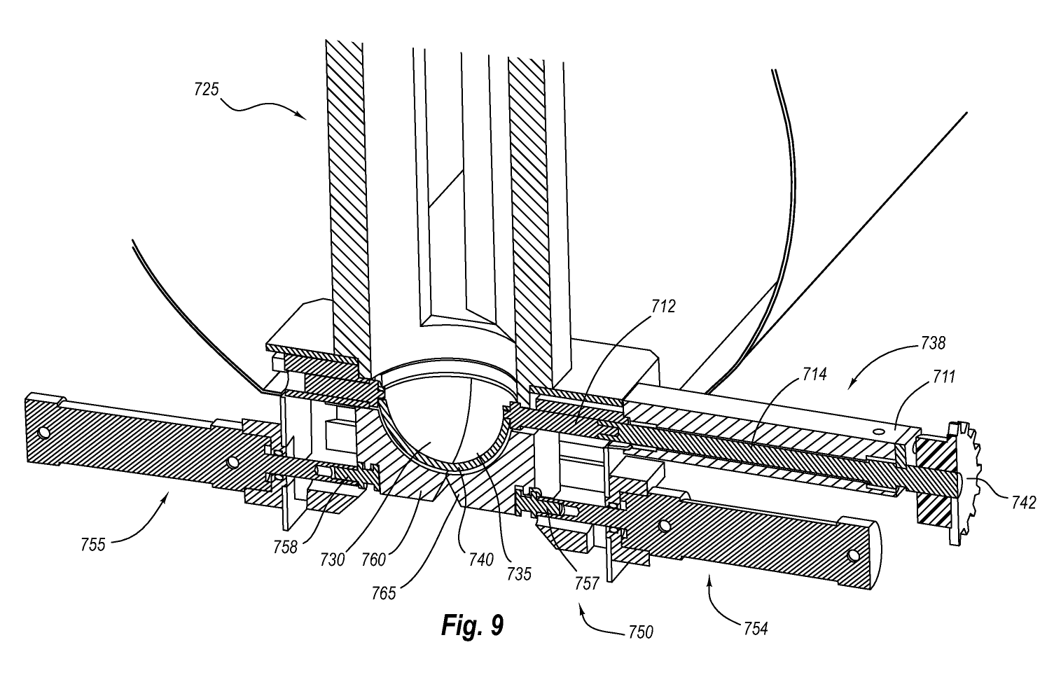

FIGS. 8 and 9 depict additional details regarding mechanisms that may be used to separate separable surfaces 430 and 435 from one another, and re-approximate separable surfaces 430 and 435, in one or more particular embodiments of the invention. FIGS. 8 and 9 depict a portioning container 725, which may be similar to portioning container 125, as previously described. FIGS. 8 and 9 also depict a wiper drive assembly 738, which includes a housing 711, a wiper drive gear 742, and a drive shaft 714. Wiper drive gear 742 may be connected with any suitable power source for driving the gear, as those having ordinary skill in the art will appreciate. Rotation of wiper drive gear 742 causes drive shaft 714 to rotate, which, in turn, causes wiper drive 740 to rotate.

FIGS. 8 and 9 also depict a second surface actuation assembly 750, which is configured to result in the separation of surfaces 730 and 735 to create an opening, as previously described. Second surface actuation assembly 750 in FIGS. 8 and 9 comprises a lower surface actuation assembly and includes two air cylinders—first air cylinder 754 and second air cylinder 755. First air cylinder 754 is configured to provide the force for moving surface 735 and second air cylinder 755 is configured to provide the force for moving surface 730. As shown in FIG. 9, air cylinders 754 and 755 have corresponding actuation members 757 and 758, respectively, with which they are connected. Actuation members 757 and 758 fit within mating recessed regions formed within the blocks 765 and 760 defining surfaces 735 and 730, respectively. As such, when the respective air cylinders 750/755 are actuated, their associated actuation members 757/758 pull on blocks 765/760 to thereby separate surfaces 735/730.

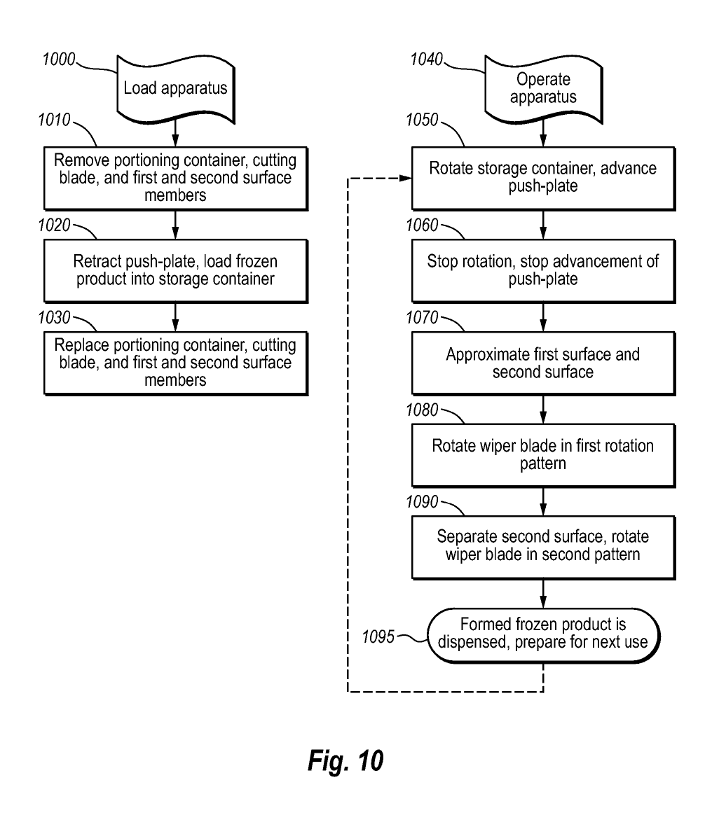

FIG. 10 shows a flow diagram of the sequence of operations in one implementation of the invention. At 1000, the portioning and dispensing apparatus is prepared for use. This may comprise a series of individual steps, such as steps 1010, 1020, and 1030. At 1010, the portioning container, cutting blade, first surface assembly, second surface assembly, and any other components blocking access to the storage container are removed from the housing. This allows a user to access the interior of the storage container. At 1020, the push-plate is retracted, allowing a user to load a frozen product, such as ice cream, into the storage container. At 1030, the apparatus is readied for operation by replacing the portioning container, cutting blade, first surface assembly, second surface assembly, and any other component removed at 1020.

At 1040, the apparatus is operated to portion and dispense the frozen product. In this particular implementation, the operation of the device consists of steps 1050, 1060, 1070, 1080, 1090, and 1095. At 1050, the storage container is rotated while the push plate simultaneously advances the frozen product in the second contain towards the cutting blade. The rotational motion and pressure from the push-plate cause the cutting blade to transfer a portion of the frozen product from the storage container into the portioning container.

At 1060, the storage container stops rotating and the push-plate stops advancing in the direction of the cutting blade. At 1070, the first surface and second surface are approximated in the portioning container. The approximation of the first surface to the second surface forms the frozen product in the portioning container into a dispensable portion.

At 1080, the wiper blade rotates in a first rotational pattern. The first rotational pattern causes the wiper blade to rotate a full 360 degrees. The first rotational pattern may cause the wiper blade to rotate multiple times if desired. At 1090, the second surface separates, allowing the formed portion of frozen product to be dispensed from the apparatus. At 1090, the wiper blade may rotate in a second rotational pattern. The second rotational pattern may cause the wiper blade to rotate in substantially only the upper 180 degrees of the region of the storage container defined by the first and second surfaces. The second rotational pattern may rotate the wiper blade in a 180-degree pattern multiple times if desired.

At 1095 the portioned frozen product is dispensed from the apparatus. The apparatus may be readied for further operation by separating the first surface from the second surface.

The above description fully discloses the invention including preferred embodiments thereof. Without further elaboration, it is believed that one skilled in the art can use the preceding description to utilize the invention to its fullest extent. Therefore the examples and embodiments disclosed herein are to be construed as merely illustrative and not a limitation of the scope of the present invention in any way.

It will be obvious to those having skill in the art that many changes may be made to the details of the above-described embodiments without departing from the underlying principles of the invention. The scope of the present invention should, therefore, be determined only by the following claims.

1. An automated apparatus for portioning a frozen product, comprising:
a portioning container for the frozen product;
a first surface connected with the portioning container; and
a second surface connected with the portioning container, wherein the frozen product in the portioning container is pressed between the first surface and second surface as the first surface and second surface are approximated within the portioning container to thereby form a dispensable portion of the frozen product.

2. The apparatus of claim 1, wherein the first surface is generally hemispherical in shape.

3. The apparatus of claim 1, wherein the second surface is separable to allow the frozen product to be dispensed from the apparatus.

4. The apparatus of claim 1, wherein the first surface is movably mounted in the portioning container and the second surface is fixed within the portioning container, and wherein the apparatus is configured such that the frozen product in the portioning container is pressed between the first surface and the second surface as the first surface moves from an upper end of the portioning container to a lower end of the portioning container.

5. The apparatus of claim 1, further comprising a wiper blade positioned in the portioning container, wherein the wiper blade is configured to sweep along at least one of the first and second surfaces.

6. The apparatus of claim 1, further comprising:
a storage container for the frozen product, wherein the storage container is connected with the portioning container; and
a cutting blade configured to transfer a portion of frozen product in the storage container to the portioning container.

7. The apparatus of claim 6, wherein the storage container is configured to rotate.

8. The apparatus of claim 7, wherein the apparatus is configured such that the cutting blade transfers a portion of the frozen product in the storage container to the portioning container responsive to rotation of the storage container.

9. The apparatus of claim 8, wherein the rotation distance of the storage container is configurable, and wherein the rotation distance affects the amount of frozen product transferred from the storage container to the portioning container.

10. The apparatus of claim 6, wherein the storage container further comprises a push plate configured to push the frozen product in the storage container in the direction of the cutting blade.

11. The apparatus of claim 10, wherein the push plate is configured to push the frozen product in the storage container in the direction of the cutting blade, and wherein the storage container is configured to rotate as the push plate pushes the frozen product in the direction of the cutting blade.

12. The apparatus of claim 10, wherein the rate with which the push plate advances is configurable, and wherein the push rate affects the amount of frozen product transferred from the storage container to the portioning container.

13. A method for portioning a frozen product, comprising:
rotating a portioning container containing the frozen product;
transferring a portion of the frozen product into a storage container responsive to the rotating;
pressing the portion of the frozen product in the storage container between a first and a second surface to create a formed portion of the frozen product; and
dispensing the formed portion of the frozen product.

14. The method of claim 13, wherein the first surface and the second surface are each generally hemispherical in shape.

15. The method of claim 13, wherein the transferring step further comprises pushing the frozen food product in the portioning container towards a front end of the portioning container.

16. The method of claim 15, wherein the transferring step further comprises slicing the frozen product with a cutting blade.

17. The method of claim 16, wherein the cutting blade is stationary as the frozen product in the portioning container is rotated and pushed towards the cutting blade.

18. The method of claim 17, wherein the cutting blade is angled with respect to the axis of rotation of the frozen product in the portioning container.

19. The method of claim 15, further comprising adjusting the rate with which the frozen food product is pushed, wherein the push rate affects the amount of frozen product transferred from the portioning container to the storage container.

20. The method of claim 13, further comprising adjusting the rate with which the portioning container is rotated, wherein the rotation rate affects the amount of frozen product transferred from the portioning container to the storage container.

21. An automated apparatus for portioning a frozen product, comprising:
means for rotating the frozen product;
means for slicing a portion of the frozen product; and
means for forming the sliced frozen product.

22. The apparatus of claim 21, further comprising means for advancing the frozen product into the forming means.

23. The apparatus of claim 22, wherein the advancing means advances the frozen product against the slicing means as the frozen product is rotated.

24. The apparatus of claim 21, further comprising means for dispensing a formed portion of the frozen product.

25. An apparatus for portioning and dispensing a frozen product, comprising:
a portioning container for the frozen product;
a hemispherically shaped first surface movably mounted in the portioning container;
a hemispherically shaped second surface mounted in a lower portion of the portioning container, wherein the second surface is separable;
a wiper blade configured to wipe the first surface and the second surface;
a storage container for the frozen product, wherein the storage container is connected with the portioning container, and wherein the storage container is configured to rotate;
a cutting blade positioned between the portioning container and the storage container; and
a push plate configured to push the frozen product in the storage container in the direction of the cutting blade, wherein the cutting blade is configured to transfer a portion of the frozen product from the storage container to the portioning container responsive to rotation of the storage container and advancement of the push-plate in the direction of the cutting blade, wherein the frozen product in the storage container is pressed into a formed portion between the first surface and second surface as the first surface is approximated with the second surface, and wherein the second surface is configured to separate to dispense the formed portion.
